(19) United States
(12) Patent Application Publication
(10) Pub. No.: US 2004/0262201 A1
(43) Pub. Date: Dec. 30, 2004

(54) Method of controlling feed variation in a valuable mineral flotation circuit

(76) Inventor: Veikko Palosaari, Pori (FI)

Correspondence Address: MORGAN & FINNEGAN, L.L.P., 3 WORLD FINANCIAL CENTER, NEW YORK, NY, 10281-2101, US

(21) Appl. No.: 10/490,589

(22) PCT Filed: Sep. 20, 2002
(86) PCT No.: PCT/FI02/00749

(30) Foreign Application Priority Data
Sep. 27, 2001 (FI) 20011893

(51) Int. Cl. B03D 1/02; B03D 1/00; B03D 1/06

(52) U.S. Cl. 209/162; 209/167

(57) ABSTRACT

The present invention relates to a method of controlling the variation in content of minerals that float naturally in the feed of a concentration plant flotation circuit processing valuable minerals, such as minerals containing precious metals, copper-, nickel- and zinc-bearing minerals. After grinding, rough flotation is performed on minerals that float naturally, such as talc, into what is termed rough talc concentrate, which is then stored. The rough talc concentrate is fed into the valuable minerals flotation circuit as a pre-defined feed, and as a result the control of the flotation circuit is improved and reagent costs are substantially reduced.

The present invention relates to a method of controlling the variation in content of minerals that float naturally in the feed of a concentration plant flotation circuit processing valuable minerals, such as minerals containing precious metals, copper-, nickel- and zinc-bearing minerals. After grinding the naturally floatable minerals, such as talc, are rougher floated as a talc rougher concentrate, which is then stored. The talc rougher concentrate is fed into the valuable minerals flotation circuit as a pre-defined flow, and as a result the control of the flotation circuit is improved and reagent costs are substantially reduced.

Swift variations in the mineral contents of concentrator feed are common, particularly in flotation circuits processing sulphide and precious metal ores. An especially difficult situation arises when contents of naturally floatable minerals (talc, chlorite, serpentine etc.) vary, so that the mass of rougher concentrate may multiply and the demand for depressants (e.g. CMC, GUAR) may change decisively. The optimal demand for depressants by ore type may vary from a few grammes up to kilos per tonne. The optimal dosage is extremely important for successful separation. A low dosage can lead to large amounts of concentrate and an increase in the MgO content of the product. Too large a dosage of depressants can make separation unselective and may result in losses of recovery, so that overdosage of depressants will always have a detrimental effect on the results.

Several alternative processes have been used to control variation, and they are described below. None of them however, have led to a result that is good regarding either the quality of the concentrate or its economy.

One method developed for the control of variations in feed is the separation-flotation of talc and taking the floated talc concentrate to tailing. Selective talc flotation succeeds however only with pure water and needs to have several cleaning stages. Circulating waters generally contain residues of collector reagents and when using them part of the valuable minerals is floated with the talc. Losses of valuable minerals to the talc product therefore are considerable.

A second method used to control feed variation is the effective homogenization of the feed material. Arranging for effective homogenization does not generally succeed in practice either due to the high cost of the system or the oxidation of sulphide minerals.

A certain method used is the dosing of depressants, which is performed according to the estimated average consumption. The result is an occasionally poor concentrate quality (too small depressant dosage) and on the other hand occasional overdosage leading to losses of valuable minerals.

Yet another method used is the evaluation of depressant dosing with estimates based on mining data. The evaluation of the timing and extent of variations is however difficult and faulty estimates lead to the problems mentioned in the previous paragraph. Estimation requires careful planning and control of mining, and adds to sampling and analysis costs.

Now a method has been developed for controlling variation in content of minerals that float naturally in the feed of a concentration plant flotation circuit processing valuable minerals. Valuable minerals within the framework of this invention are for instance minerals containing precious metals or copper-, nickel- and zinc-bearing minerals. Using this method will make it possible to avoid the drawbacks presented above and reach an even recovery. The essential features of the invention will be made apparent in the attached claims.

In the method according to the present invention, minerals that float naturally such as talc, chlorite and serpentine, are pre-floated after grinding of the sulphide and/or precious metal ore into a talc rougher concentrate using only a frother. In order to improve selectivity flotation is performed at relatively low pulp densities. In the text the term talc rougher concentrate is used, although clearly it essentially contains other naturally floatable minerals too. The rougher talc concentrate is stored and for instance a thickener or storage tank can be used for this purpose.

The main feed for the actual flotation of valuable minerals i.e. the tailing of talc pre-flotation is thickened to the optimal pulp density for the separation of valuable minerals. The amount of talc rougher concentrate is measured and fed in a controlled manner back into the main feed in connection with the conditioning of the valuable mineral flotation circuit. It is advantageous to use the overflow waters from thickening, both from the talc rougher concentrate collection tank and from main feedstock thickening, as circulation water in grinding, whereby the residual chemicals content falls as a result of natural adsorption in grinding and the selectivity of the talc rougher flotation is improved.

The depressant dosing for valuable mineral flotation is measured according to the amount and if necessary according to the quality of talc rougher concentrate to be fed, so that variations in depressant demand are evened out. As a result the costs of reagents are reduced, the control of the circuit is enhanced and therefore both the quality and the yield of the concentrate produced is improved. Since the rougher concentrate is fed back into the circuit, there are no great demands set on the selectivity of talc rougher flotation, so that for instance the circulating water from tailing thickening or circulated from the tailing area can be used as process water in both grinding and talc rougher flotation. No great demands need to be set for mining selectivity because talc-containing ores can be processed without major process disruptions and quality variation in the products. Thus high talc ore bodies can also be utilized.

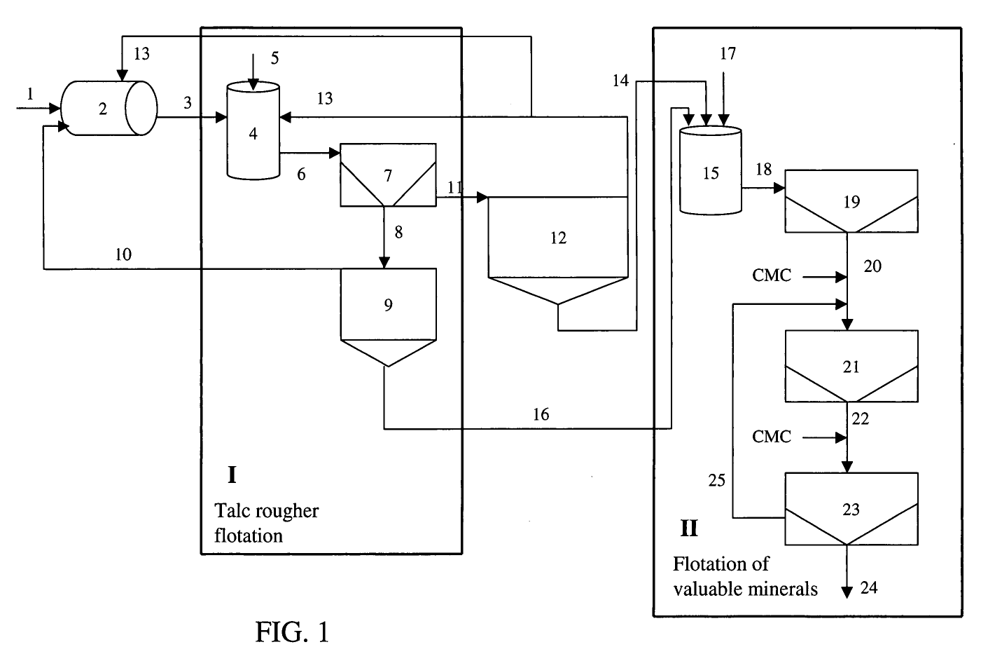

The invention is further described by the process flowchart in FIG. 1.

The ore to be concentrated 1 such as an ore containing sulphides or precious metals is fed to grinding 2, as is circulating water. At least part of the circulating water 10, 13, comes from later stages of the concentration process, but it can also be circulating water returned from elsewhere (not shown in detail in the diagram). The fine-grained ore slurry 3 from grinding is fed to the talc rougher flotation circuit I conditioner 4, where it is diluted to a suitable slurry density, 10-25%, preferably 15-20% using circulating water 13. The only reagents put into the conditioner 4 are frothers 5. One frother used for talc and other naturally floatable minerals is for instance methyl-isobutylcarbinol (MIBC). The ore 6 pre-treated in the conditioner is fed into the rougher flotation circuit 7, where the rougher flotation is performed. Talc and other naturally floatable minerals float as talc rougher concentrate 8 and are fed to a storage tank 9, which may be a thickener, for example. The overflow water 10 from the thickener can be recirculated to grinding as circulating water.

The tailing 11 from rougher flotation is a slurry containing valuable minerals, which it is preferable to thicken before the actual valuable mineral flotation. The tailing 11 is fed into a thickener 12, where it is thickened to a suitable pulp density for the actual flotation, which is typically in the region of 30-40%. The overflow from thickening 13 can be used as circulating water in various stages of the process such as grinding 2 and the conditioner of the rougher flotation circuit 4. The thickened, valuable mineral-containing slurry 14 is fed to the valuable minerals flotation circuit II conditioner 15. A measured amount of talc rougher concentrate 16 is also fed into the conditioning reactor 15. In addition, reagents 17 are also fed into the conditioner, mainly collectors, frothers and depressants (e.g. xanthate, MIBC, CMC (=carboxymethylcellulose)). When the amount of talc rougher concentrate entering the valuable minerals flotation circuit is thus kept fixed, this makes it possible to adjust the amount of reagents to be fed, in particular the amount of depressants, to correspond to the real demand.

From the conditioner 15 the mineral slurry 18 is fed to the first flotation cell 19 in the valuable minerals flotation circuit II. Obviously, the valuable minerals flotation circuit can be operated as in the prior art. If the feed does not require conditioning, the rougher concentrate can be fed directly to the start of the flotation circuit or to one of its later stages, e.g. scavenger flotation. The essential thing is that rougher flotation of naturally floatable minerals is performed on the ore, and that the rougher concentrate obtained is fed back to the valuable minerals flotation as a controlled flow, where it is possible to adjust the amount of reagents, in particular that of the depressant reagent, in order to correspond to the demand.

According to FIG. 1 the concentrate 20 produced in the combined rougher and scavenger flotation 19 are cleaned in cell 21 and from there the concentrate obtained 22 is recleaned in cell 23. Further depressant reagents can be added to each flotation stage. In the figure, this is illustrated by one suitable depressant CMC, although clearly other depressants may also be used. In the final cell the concentrate obtained 24 is ready after water separation for example to be taken to further concentrate treatment, which may be either pyro- or hydrometallurgical. The tailing from the cells can be recirculated counter-currently as shown by recirculation 25 in the diagram. Final tailing is removed from the last cell in the flotation circuit.

1. A method of controlling the content of minerals that float naturally in the feed of a concentration plant flotation circuit processing valuable minerals, comprising after grinding, performing rougher flotation on minerals that float naturally into what is termed rougher concentrate, then storing the rougher concentrate using tailing of rougher concentrates the main feed of the valuable minerals flotation circuit and adding the rougher concentrate as a pre-measured flow before flotation.

2. A method according to claim 1, further comprising using depressants in flotation in the valuable minerals flotation circuit.

3. A method according to claim 2, further comprising measuring the depressant dosage based on the amount of rougher concentrate.

4. A method according to claim 2, further comprising measuring the depressant dosage based on the amount and quality of the rougher concentrate.

5. A method according to claim 1, wherein the valuable minerals are minerals that contain precious metals.

6. A method according to claim 1, wherein the valuable minerals are minerals that bear copper.

7. A method according to claim 1, wherein the valuable minerals are minerals that bear nickel.

8. A method according to claim 1, wherein the valuable minerals are minerals that bear zinc.

9. A method according to claim 1, further comprising performing thickening on the rougher concentrate during storage.

10. A method according to claim 9, further comprising using the overflow of the thickening of the rougher concentrate as circulating water in grinding.

11. A method according to claim 1, further comprising thickening rougher flotation at a slurry content of 10-25%.

12. A method according to claim 1, further comprising thickening the main feed of the valuable minerals flotation circuit after rougher flotation.

13. A method according to claim 12, further comprising using overflow of the thickening of the main feed of the valuable minerals flotation as circulating water in grinding and/or in rougher flotation.

14. A method according to claim 1, wherein the mineral to be floated naturally is talc.

15. A method according to claim 1, wherein the mineral to be floated naturally is chlorite.

16. A method according to claim 1, wherein the mineral to be floated naturally is serpentine.

17. A method according to claim 1, further comprising using frothers in rougher flotation.

18. A method according to claim 17, wherein the frother used in rougher flotation is MIBC (methyl-isobutylcarbinol).
